(19) United States
(12) Patent Application Publication
(10) Pub. No.: US 2016/0137889 A1
(43) Pub. Date: May 19, 2016

(54) BONDPLY ADHESIVE COMPOSITION

(71) Applicant: E I DU PONT DE NEMOURS AND COMPANY, Wilmington, DE (US)

(72) Inventor: TUNG LIN LI, NEW TAIPEI CITY (TW)

(21) Appl. No.: 14/943,491

(22) Filed: Nov. 17, 2015

Related U.S. Application Data
(60) Provisional application No. 62/081,254, filed on Nov. 18, 2014.

(51) Int. Cl. C09J 151/00

(52) U.S. Cl. CPC C09J 151/003; C08K 5/5435

(57) ABSTRACT

The present disclosure is directed to a bondply adhesive. The bondply adhesive contains 85 to 99.5 wt % maleic anhydride grafted styrene ethylene butadiene styrene copolymer having greater than 1 wt % maleic anhydride, 0.4 to 3.0 wt % 3-glycidyloxypropyl-trimethoxysilane, and optionally up to 14 wt % organic flame retardant.

### FIELD OF DISCLOSURE

This disclosure relates generally to adhesives. More specifically, the disclosure relates to bondply adhesive compositions.

### BACKGROUND OF THE DISCLOSURE

Adhesives for coverlay or bondply materials for high frequency applications used in flexible printed circuit board (FPCB) must have low Dₖ (dielectric constant) and low D_{f} (dissipation factor or loss tangent) to address the need for high speed signal transmission with low signal loss. The industry also desires lower lamination temperatures while maintaining good peel strength, as well as good solder resistance for bondply applications.

Adhesive compositions for these applications often include epoxy and/or fluorine polymer filler particles dispersed in the resin to reduce the dielectric constant and loss in these compositions. However, the heat resistance of these adhesives is poor due the decomposition of fluorine polymer fillers at high temperature (288° C.). Resin formulations comprising poly(phenyl ether) (PPE) with vinyl functional groups, hydrogenated styrene butadiene styrene copolymer (SEBS) and epoxy/hardener to achieve low dielectric and loss tangent properties are known, however, their lamination temperatures are too high (exceeding 200° C.), which cannot meet conventional processing temperatures (180° C.).

For the forgoing reasons, a need exists for adhesive compositions having low Dₖ (dielectric constant) and low D_{f} (dissipation factor or loss tangent), good peel strength, good solder resistance and lower lamination temperatures.

### SUMMARY

The present disclosure is directed to a bondply adhesive consisting essentially thereof:

I. 85 to 99.5 wt % maleic anhydride grafted styrene ethylene butadiene styrene copolymer having greater than 1 wt % maleic anhydride;

II. 0.4 to 3.0 wt % 3-glycidyloxypropyl-trimethoxysilane; and

III. optionally up to 14 wt % organic flame retardant.

### DETAILED DESCRIPTION

### Definitions

As used herein, the terms “comprises,” “comprising,” “includes,” “including,” “has,” “having” or any other variation thereof, are intended to cover a non-exclusive inclusion. For example, a method, process, article, or apparatus that comprises a list of elements is not necessarily limited only to those elements but may include other elements not expressly listed or inherent to such method, process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of the “a” or “an” are employed to describe elements and components of the invention. This is done merely for convenience and to give a general sense of the invention. This description should be read to include one or at least one and the singular also includes the plural unless it is obvious that it is meant otherwise.

The term “film” as used herein is intended to mean a free-standing film or a (self-supporting or non-self-supporting) coating. The term “film” is used interchangeably with the term “layer” and refers to covering a desired area.

The present disclosure is directed to an adhesive. The adhesive is well suited for high speed high frequency applications and more particularly to a bondyply adhesive for high speed high frequency applications. Adhesives for high speed high frequency applications need to have low Dₖ (dielectric constant) and low Df (dissipation factor or loss tangent) and high peel strength.

It has been found that maleic anhydride functionalized SEBS provides increased peel strength over unmodified SEBS and does not increase the Dₖ or D_{f} and in some embodiments desirably lowers the Dₖ and/or D_{f}. In some embodiments, the maleic anhydride grafted styrene ethylene butadiene styrene copolymer is present from 85 to 99.5 wt % based on the total weight of the bondply adhesive. In some embodiments, the maleic anhydride grafted styrene ethylene butadiene styrene copolymer is present from 85.27 to 99.5 wt % based on the total weight of the adhesive.

In some embodiments, the maleic anhydride grafted styrene ethylene butadiene styrene copolymer has greater than 1 wt % maleic anhydride based on the total weight of the maleic anhydride grafted styrene ethylene butadiene styrene copolymer. In some embodiments, the amount of maleic anhydride is greater than 1 wt % and less than 2 wt %. In some embodiments, maleic anhydride grafted styrene ethylene butadiene styrene copolymer has greater than 1 wt % and less than 2 wt % maleic anhydride. In some embodiments, maleic anhydride grafted styrene ethylene butadiene styrene copolymer has greater than 1 wt % and less than 1.7 wt % maleic anhydride.

The bondply adhesive composition contains 3-glycidyloxypropyl-trimethoxysilane (GLYMO). The addition of GLYMO enables the adhesive to be used in a bondply structure, as the adhesive containing GLYMO passes a solder float test at 288° C. for 10 seconds. In some embodiments, the bondply adhesive contains 0.4 to 5 wt % 3-glycidyloxypropyl-trimethoxysilane. In some embodiments, the bondply adhesive contains 0.4 to 3 wt % 3-glycidyloxypropyl-trimethoxysilane. In another embodiment, the bondply adhesive contains 0.44 to 3 wt % 3-glycidyloxypropyl-trimethoxysilane. While the addition of GLYMO enables the adhesive to be used as a bondply adhesive (solder resistant), the bondply adhesive composition of the present disclosure could also be used as an adhesive for a coverlay which does not require solder resistance.

In some embodiments, the bondply adhesive contains up to and including 14 wt % organic flame retardant. In another embodiment, the bondply adhesive contains 11 to 12 wt % organic flame retardant. In another embodiment, the bondply adhesive contains 11.5 to 11.8 wt % organic flame retardant. In some embodiments, the organic flame retardant is an organophosphorus salt.

One advantage of the bondply adhesive of the present disclosure is the epoxy resin that is traditionally needed in such adhesive compositions can be eliminated. The bondply adhesive of the present disclosure has good peel strength and dielectric properties required for high speed high frequency applications without an epoxy resin.

A bondply adhesive solution can be prepared by mixing each bondply adhesive component and solvent in any order at appropriate concentration for coating on a dielectric layer. After a homogeneous solution without precipitate is obtained, the bondply adhesive solution is coated onto a dielectric layer, typically, but not limited to, a polyimide layer. For the purpose of this disclosure, the polyimide layer used is Kapton® 50ENS (polyimide film available from DuPont-Toray Co., Ltd., Japan).

In some embodiments, suitable solvents are methyl ethyl ketone (MEK), toluene or mixture thereof. Routine experimentation may identify other suitable solvents for homogeneous solution of bondply adhesive components of the present disclosure.

Coating methods include, but are not limited to, spray coating, curtain coating, knife over roll, air knife, extrusion/slot die, gravure, reverse gravure, offset gravure, roll coating, and dip/immersion. In some embodiments board coating may be used.

After coating, the adhesive coated dielectric layer is put into a 120° C. oven for 5 minutes to evaporate the solvent. The temperature and length of time in the oven will depend on the solvent used and thickness of the adhesive. The thickness of the bondply adhesive can be controlled in accordance with the coating method used. For example, board coating can control the thickness of the bondply adhesive by adjusting the gap of the coating fixture. In some embodiments, the thickness of the bondply adhesive is from 10 to 60 microns. In another embodiment, the thickness of the bondply adhesive is from 10 to 30 microns.

The bondply adhesive coated dielectric layer may be laminated on the shiny side of rolled annealed (RA) copper foil. Any conventional lamination method may be used. One advantage of the bondply adhesive of the present disclosure is that lower lamination temperatures may be used. The bondply adhesive of the present disclosure can be laminated to copper foil at temperatures of about 180° C. and still have good peel strength. In some embodiments, the bondply sample may be laminated to copper foil at 180° C. for 120 seconds by using a quick lamination machine.

One advantage of the bondply adhesive layer of the present disclosure is solder resistance. Solder resistance is required for bondply applications where the copper foil is imaged.

Another advantage of the bondply adhesive of the present disclosure is good peel strength, and in some embodiments increased peel strength. The bondply adhesive has a peel strength of at least 0.5 N/mm when laminated to copper foil at 180° C. for 120 seconds. In some embodiments, the bondply adhesive has a peel strength of 0.5 to 0.85 N/mm when laminated to copper foil at 180° C. for 120 seconds. In some embodiments, the bondply adhesive has a peel strength of 0.5 to 0.832 N/mm when laminated to copper foil at 180° C. for 120 seconds. The copper foil can be any commercial available copper foil. The copper foil is typically RA copper foil (1/2 oz).

Another advantage of the bondply adhesive of the present disclosure is the Dₖ and D_{f} are sufficiently low enough to enable the bondply adhesive to be used in high speed high frequency (1 to 20 GHz) applications. The bondply adhesive of the present disclosure has a dielectric constant from 2.6 to 3.0 at 10 GHz and dissipation factor from 0.0040 to 0.0070 at 10 GHz. In another embodiment, the bondply adhesive of the present disclosure has a dielectric constant from 2.63 to 2.8 at 10 GHz and a dissipation factor from 0.0043 to 0.0070 at 10 GHz.

The bondply adhesive may contain additional fillers. In some embodiments, the bondply adhesive contains dielectric filler or mixtures of dielectric fillers. Examples of useful dielectric fillers are, but are not limited to, aluminum oxide, silica, calcium carbonate, magnesium carbonate, magnesium calcium carbonate, calcium oxide, magnesium oxide, talc, magnesium silicates, aluminum silicates, magnesium aluminum silicates, calcium silicates, clay, mica, barium sulfate, boron nitride, aluminum nitride, barium titanate, strontium titanate, alumina trihydrate and calcium sulphate.

In some embodiments, the bondply adhesive of the present disclosure consists essentially thereof:

I. 85 to 99.5 wt % maleic anhydride grafted styrene ethylene butadiene styrene copolymer having greater than 1 wt % maleic anhydride; and

II. 0.4 to 3.0 wt % 3-glycidyloxypropyl-trimethoxysilane.

In some embodiments, the bondply adhesive of the present disclosure consists essentially thereof:

I. 85 to 99.5 wt % maleic anhydride grafted styrene ethylene butadiene styrene copolymer having greater than 1 wt % maleic anhydride;

II. 0.4 to 3.0 wt % 3-glycidyloxypropyl-trimethoxysilane; and

III. optionally up to 14 wt % inorganic flame retardant.

In some embodiments, the bondply adhesive of the present disclosure consists essentially thereof:

I. 85 to 99.5 wt % maleic anhydride grafted styrene ethylene butadiene styrene copolymer having greater than 1 wt % maleic anhydride;

II. 0.4 to 3.0 wt % 3-glycidyloxypropyl-trimethoxysilane; and

III. optionally 11 to 12 wt % inorganic flame retardant.

In some embodiments, the bondply adhesive of the present disclosure consists essentially thereof:

I. 85 to 99.5 wt % maleic anhydride grafted styrene ethylene butadiene styrene copolymer having greater than 1 wt % maleic anhydride;

II. 0.4 to 3.0 wt % 3-glycidyloxypropyl-trimethoxysilane; and

III. optionally up to 14 wt % organophosphorus salt.

In some embodiments, the bondply adhesive of the present disclosure consists essentially thereof:

I. 85 to 99.5 wt % maleic anhydride grafted styrene ethylene butadiene styrene copolymer having greater than 1 wt % maleic anhydride;

II. 0.4 to 3.0 wt % 3-glycidyloxypropyl-trimethoxysilane; and

III. optionally 11 to 12 wt % organophosphorus salt.

In some embodiments, the bondply adhesive of the present disclosure consists essentially thereof:

I. 85 to 99.5 wt % maleic anhydride grafted styrene ethylene butadiene styrene copolymer having greater than 1 wt % and less than 2 wt % maleic anhydride; and

II. 0.4 to 3.0 wt % 3-glycidyloxypropyl-trimethoxysilane.

In some embodiments, the bondply adhesive of the present disclosure consists essentially thereof:

I. 85 to 99.5 wt % maleic anhydride grafted styrene ethylene butadiene styrene copolymer having greater than 1 wt % and less than 2 wt % maleic anhydride;

II. 0.4 to 3.0 wt % 3-glycidyloxypropyl-trimethoxysilane; and

III. optionally up to 14 wt % inorganic flame retardant.

In some embodiments, the bondply adhesive of the present disclosure consists essentially thereof:

I. 85 to 99.5 wt % maleic anhydride grafted styrene ethylene butadiene styrene copolymer having greater than 1 wt % and less than 2 wt % maleic anhydride;

II. 0.4 to 3.0 wt % 3-glycidyloxypropyl-trimethoxysilane; and

III. optionally 11 to 12 wt % inorganic flame retardant.

In some embodiments, the bondply adhesive of the present disclosure consists essentially thereof:

I. 85 to 99.5 wt % maleic anhydride grafted styrene ethylene butadiene styrene copolymer having greater than 1 wt % and less than 2 wt % maleic anhydride;

II. 0.4 to 3.0 wt % 3-glycidyloxypropyl-trimethoxysilane; and

III. optionally up to 14 wt % organophosphorus salt.

In some embodiments, the bondply adhesive of the present disclosure consists essentially thereof:

I. 85 to 99.5 wt % maleic anhydride grafted styrene ethylene butadiene styrene copolymer having greater than 1 wt % and less than 2 wt % maleic anhydride;

II. 0.4 to 3.0 wt % 3-glycidyloxypropyl-trimethoxysilane; and

III. optionally 11 to 12 wt % organophosphorus salt.

When an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. Numerical values are to be understood to have the precision of the number of significant figures provided. For example, the number 1 shall be understood to encompass a range from 0.5 to 1.4, whereas the number 1.0 shall be understood to encompass a range from 0.95 to 1.04, including the end points of the stated ranges. It is not intended that the scope of the invention be limited to the specific values recited when defining a range.

In describing certain polymers it should be understood that sometimes applicants are referring to the polymers by the monomers used to make them or the amounts of the monomers used to make them. While such a description may not include the specific nomenclature used to describe the final polymer or may not contain product-by-process terminology, any such reference to monomers and amounts should be interpreted to mean that the polymer is made from those monomers, unless the context indicates or implies otherwise.

The materials, methods, and examples herein are illustrative only and, except as specifically stated, are not intended to be limiting. Although methods and materials similar or equivalent to those described herein can be used, suitable methods and materials are described herein.

### EXAMPLES

The invention will be further described in the following examples, which is not intended to limit the scope of the invention described in the claims. The materials, methods, and examples herein are illustrative only and, except as specifically stated, are not intended to be limiting. Although methods and materials similar or equivalent to those described herein can be used in the practice or testing of the present invention, suitable methods and materials are described herein.

Adhesive solution was prepared by mixing each ingredient and solvent at an appropriate concentration. After a homogeneous solution was obtained (without any precipitate), it was applied onto Kapton® 50ENS (polyimide film available from DuPont-Toray, thickness of 12.5 microns) and was put into a 120° C. oven for 5 minutes to evaporate the solvent. Bondply samples were prepared having an adhesive thickness of 20 microns for peel strength measurements and solder tests, and 50 microns for dielectric measurements.

Peel strength was measured with an AG1 Universal Testing Machine (Shimadzu Corp., Japan) following a 180 degree peel test method. Bondply samples were prepared with the bondply adhesive on a dielectric layer which was then laminated to RA copper foil (1/2 oz, JX-Nippon Mining & Metals Corp., Japan) with a quick lamination machine at 180° C. for 120 seconds. After that, the samples were placed into an oven at 180° C. for 1 hr. Multiple specimens were prepared with a size of 1 mm width and 8 cm length. The average of 5-10 individual measurements was recorded.

Dielectric properties (Dₖ/D_{f}) were measured using an Agilent PNA Network Analyzer with installed 85071E software and a resonance cavity frequency of 10 GHz. Samples were prepared with the dielectric layer only by heating in an oven at 180° C. for 1 hr before testing. The individual sample size was 8 cm by 10 cm. The average of 2-3 individual measurements was recorded.

For solder tests, a bondply adhesive sample was prepared with the bondply adhesive on a dielectric layer which was then laminated to RA copper foil (1/2 oz) with a quick lamination machine at 180° C. for 120 seconds. After that, the sample was placed into an oven at 180° C. for 1 hr. Individual samples were 5 cm by 5 cm. Samples were floated on the solder surface at 288° C. for 10 seconds and visually inspected for defects (e.g., blistering, delamination, etc.). The average of 3 individual measurements was recorded. Visual inspection was recorded as “pass” only if all three samples were defect-free. If any of the three samples had defects, it was recorded as “fail”.

Examples 1-7 and Comparative Examples 1-4 demonstrate that adhesives having maleic anhydride grafted SEBS (MA-g-SEBS) systems, with and without GLYMO and different grafted MA amounts, can achieve desirable dielectric properties for bondply adhesive applications, with good solder resistance as well as good peel strength.

### Example 1

An adhesive solution was prepared, consisting of 99.5 wt % MA-g-SEBS (Taipol SEBS 7131, containing 1.38 wt % maleic anhydride, available from Taiwan Synthetic Rubber Corp. (TSRC), Taiwan), 0.5 wt % coupling agent (GLYMO available from Evonik Industries, Germany) and toluene as solvent. The solution was mixed by mechanical stirring until it became a homogeneous solution (no precipitate) then coated on a 0.5 mil (12.5 micron) Kapton® 50ENS polyimide film using a board coater (Coatmaster 509MC, Erichsen GmbH & Co. KG, Germany). After that, the coated film was placed into an oven at 120° C. for 5 mins to eliminate the solvent.

For peel strength and solder inspection, bondply samples were prepared as described above.

For Dₖ and D_{f} measurements, adhesive thickness was controlled at 50 microns on Kapton® 50ENS. Sample preparation and measurement are described above.

Results are shown in Table 1.

### Example 2

An adhesive solution was prepared, consisting of 87.75 wt % MA-g-SEBS (Taipol SEBS 7131), 11.8 wt % organophosphorus salt (Exolit® OP 935 available from Clariant SE, Switzerland), 0.44 wt % coupling agent (GLYMO available from Evonik) and toluene as solvent. The solution was mixed, coated on polyimide film and dried following the procedure of Example 1.

For peel strength, solder inspection and dielectric measurement, the test methods are the same as Example 1.

Results are shown in Table 1.

### Example 3

An adhesive solution was prepared, consisting of 87.27 wt % MA-g-SEBS (Taipol SEBS 7131), 11.8 wt % organophosphorus salt (Exolit® OP 935), 1.0 wt % coupling agent (GLYMO) and toluene as solvent. The solution was mixed, coated on polyimide film and dried following the procedure of Example 1.

For peel strength, solder inspection and dielectric measurement, the test methods are the same as Example 1.

Results are shown in Table 1.

### Example 4

An adhesive solution was prepared, consisting of 85.57 wt % MA-g-SEBS (Taipol SEBS 7131), 11.5 wt % organophosphorus salt (Exolit® OP 935), 3.0 wt % coupling agent (GLYMO) and toluene as solvent. The solution was mixed, coated on polyimide film and dried following the procedure of Example 1.

For peel strength, solder inspection and dielectric measurement, the test methods are the same as Example 1.

Results are shown in Table 1.

### Comparative Example 1

An adhesive solution was prepared, consisting of 100.0 wt % SEBS (Taipol SEBS 6152 available from TSRC) and toluene as solvent. The solution was mixed, coated on polyimide film and dried following the procedure of Example 1.

For peel strength, solder inspection and dielectric measurement, the test methods are the same as Example 1.

Results are shown in Table 1.

### Comparative Example 2

An adhesive solution was prepared, consisting of 100.0 wt % MA-g-SEBS (Taipol SEBS 7131) and toluene as solvent. The solution was mixed, coated on polyimide film and dried following the procedure of Example 1.

For peel strength, solder inspection and dielectric measurement, the test methods are the same as Example 1.

Results are shown in Table 1.

### Comparative Example 3

An adhesive solution was prepared, consisting of 87.75 wt % MA-g-SEBS (Taipol SEBS 7131), 11.8 wt % organophosphorus salt (Exolit® OP 935), 0.44 wt % 3-glycidyloxypropyl-triethoxysilane coupling agent (GLYEO available from Evonik) and toluene as solvent. The solution was mixed, coated on polyimide film and dried following the procedure of Example 1.

For peel strength, solder inspection and dielectric measurement, the test methods are the same as Example 1.

Results are shown in Table 1.

### Example 5

An adhesive solution was prepared, consisting of 87.70 wt % MA-g-SEBS (Taipol SEBS 7131) which MA grafted mount is 1.3 wt %, 11.81 wt % organophosphorus salt (Exolit® OP 935), 0.44 wt % coupling agent (GLYMO) and toluene as solvent. The solution was mixed, coated on polyimide film and dried following the procedure of Example 1.

For peel strength, solder inspection and dielectric measurement, the test methods are the same as Example 1.

Results are shown in Table 2.

### Example 6

An adhesive solution was prepared as Example 5 with MA-g-SEBS (Taipol SEBS 7131) which MA grafted amount is 1.38 wt %.

Results are shown in Table 2.

### Example 7

An adhesive solution was prepared as Example 5 with MA-g-SEBS (Taipol SEBS 7131) which MA grafted amount is 1.6 wt %.

Results are shown in Table 2

### Comparative Example 4

An adhesive solution was prepared as Example 5 with MA-g-SEBS (Taipol SEBS71731) which MA grafted amount is 1.0 wt %.

Results are shown in Table 2.

Note that not all of the activities described above in the general description or the examples are required, that a portion of a specific activity may not be required, and that further activities may be performed in addition to those described. Still further, the order in which each of the activities are listed are not necessarily the order in which they are performed. After reading this specification, skilled artisans will be capable of determining what activities can be used for their specific needs or desires.

In the foregoing specification, the invention has been described with reference to specific embodiments. However, one of ordinary skill in the art appreciates that various modifications and changes can be made without departing from the scope of the invention as set forth in the claims below. All features disclosed in this specification may be replaced by alternative features serving the same, equivalent or similar purpose. Accordingly, the specification is to be regarded in an illustrative rather than a restrictive sense and all such modifications are intended to be included within the scope of the invention.

TABLE 1

| | wt % | wt % | wt % | | | Peel | Dₖ | D_{f} | Solder |
|---|---|---|---|---|---|---|---|---|---|
| | unmodified | MA-g- | flame | wt % | wt % | Strength | (@ 10 | (@ 10 | 288° C. |
| | SBS | SEBS | retardant | GLYMO | GLYEO | (N/mm) | GHz) | GHz) | 10 s |
| Example 1 | — | 99.50 | — | 0.50 | — | 0.83 | 2.75 | 0.0070 | pass |
| Example 2 | — | 87.75 | 11.8 | 0.44 | — | 0.53 | 2.68 | 0.0060 | pass |
| Example 3 | — | 87.27 | 11.8 | 1.00 | — | 0.50 | 2.75 | 0.0060 | pass |
| Example 4 | — | 85.57 | 11.5 | 3.00 | — | 0.53 | 2.70 | 0.0062 | pass |
| Comp. Ex 1 | 100.00 | — | — | — | — | 0.47 | 2.64 | 0.0062 | fail |
| Comp. Ex 2 | — | 100.00 | — | — | — | 1.09 | 2.67 | 0.0065 | fail |
| Comp. Ex 3 | — | 87.75 | 11.8 | — | 0.44 | 0.50 | 2.86 | 0.0062 | fail |

TABLE 2

| | wt % MA | wt % | wt % | | Peel | Dₖ | D_{f} | Solder |
|---|---|---|---|---|---|---|---|---|
| | grafted | MA-g- | flame | wt % | Strength | (@ 10 | (@ 10 | 288° C. |
| | on SEBS | SEBS | retardant | GLYMO | (N/mm) | GHz) | GHz) | 10 s |
| Example 5 | 1.30 | 87.70 | 11.81 | 0.44 | 0.57 | 2.73 | 0.0044 | pass |
| Example 6 | 1.38 | 87.70 | 11.81 | 0.44 | 0.51 | 2.80 | 0.0062 | pass |
| Example 7 | 1.60 | 87.70 | 11.81 | 0.44 | 0.55 | 2.63 | 0.0043 | pass |
| Comp. Ex 4 | 1.00 | 87.70 | 11.81 | 0.44 | 0.56 | 2.58 | 0.0053 | fail |

What is claimed is:

1. A bondply adhesive consisting essentially thereof:
I. 85 to 99.5 wt % maleic anhydride grafted styrene ethylene butadiene styrene copolymer having greater than 1 wt % maleic anhydride;
II. 0.4 to 3.0 wt % 3-glycidyloxypropyl-trimethoxysilane; and
III. optionally up to 14 wt % organic flame retardant.

2. The bondply adhesive in accordance with claim 1 wherein said maleic anhydride grafted styrene ethylene butadiene styrene copolymer has greater than 1 wt % and less than 2 wt % maleic anhydride.

3. The bondply adhesive in accordance with claim 1 wherein the organic flame retardant is an organophosphorus salt.

4. The bondply adhesive in accordance with claim 1 having a peel strength of at least 0.50 N/mm when laminated to copper foil at 180° C. for 120 seconds.

5. The bondply adhesive in accordance with claim 1 having a peel strength of 0.50 to 0.85 N/mm when laminated to copper foil at 180° C. for 120 seconds.

6. The bondply adhesive in accordance with claim 1 having a dielectric constant from 2.6 to 3.0 at 10 GHz and a dissipation factor from 0.0040 to 0.0070 at 10 GHz.
